(19) United States
(12) Patent Application Publication
(10) Pub. No.: US 2021/0342419 A1
(43) Pub. Date: Nov. 4, 2021

(54) BUNDLED ENTERPRISE APPLICATION USERS

(71) Applicants: Henry K Moon, Duluth, GA (US); Clayton C Hofelich, Sandy Springs, GA (US)

(72) Inventors: Henry K Moon, Duluth, GA (US); Clayton C Hofelich, Sandy Springs, GA (US)

(21) Appl. No.: 16/865,047

(22) Filed: May 1, 2020

(51) Int. Cl. G06F 21/10; H04L 29/06; H04L 9/08; G06F 21/60

(52) U.S. Cl. CPC G06F 21/105; H04L 63/0209; G06F 2221/0713; H04L 63/065; G06F 21/602; H04L 9/0833

(57) ABSTRACT

A system and method for providing enterprise software applications to a plurality of bundled users is disclosed.

### TECHNICAL FIELD

This application relates in general to a system and method for providing enterprise software, and more specifically, to a system and method for providing enterprise software applications to a plurality of bundled users.

### BACKGROUND

Current state of the art in large scale software programs geared to improving organizational processes is limited to those companies of size that can afford the expensive license and implementation and maintenance costs. Smaller entities, which represent the largest number of organizations in need of these process improvements, do not have access to these software products because of the cost. As such, these entities are unable to benefit from the improved business processes.

Therefore, a need exists for a process whereby a group of independent small firms can form a limited entity designed exclusively to cost-share and gain the benefits of large-scale software systems. This process would allow for large enterprise applications to be utilized by smaller companies that due to high costs do not normally have access to the technology. Smaller companies will be bundled in an efficient manner within one software license. Security measures within the software will provide a firewall between companies bundled under the same platform. Software licenses will be managed by an umbrella LLC and use of the software provided to companies within the bundle. Implementations, support, and licenses can all be managed under a parent LLC providing economies of scale that would otherwise not be available to small companies.

### SUMMARY

In accordance with the present invention, the above and other problems are solved by providing a system and method for providing enterprise software applications to a plurality of bundled users according to the principles and example embodiments disclosed herein.

In one embodiment, the present invention is a system for providing enterprise software applications to a plurality of bundled users.

In another embodiment, the present invention is a method for providing enterprise software applications to a plurality of bundled users.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides enterprise software applications to a plurality of bundled users according to the present invention.

FIG. 2a is a block diagram illustrating an exemplary hardware architecture of a computing device.

FIG. 2b is a block diagram illustrating an exemplary logical architecture for a client device.

FIG. 2c is a block diagram showing an exemplary architectural arrangement of clients, servers, and external services.

FIG. 2d is another block diagram illustrating an exemplary hardware architecture of a computing device.

FIGS. 3a-d illustrate example embodiments of a system for providing enterprise software applications to a plurality of bundled users according to the present invention.

FIG. 4 illustrates a computing system of software components within a message processor providing enterprise software applications to a plurality of bundled users according to the present invention.

FIG. 5 illustrates a flowchart corresponding to a method performed by software components providing enterprise software applications to a plurality of bundled users according to the present invention.

### DETAILED DESCRIPTION

This application relates in general to a system and method for providing enterprise software applications, and more specifically, to a system and method for providing enterprise software applications to a plurality of bundled users according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology may be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers” should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The term “mobile application” refers to an application executing on a mobile device such as a smartphone, tablet, and/or web browser on any computing device.

The term “enterprise application” refers to an application executing on any computing device relating to functions performed by users related to the operation of entire business entities.

The terms “customer,” “client,” and “user” refer to an entity, e.g. a human, using enterprise applications for bundled users including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are included below in this application.

The term “invention” or “present invention” refers to the invention being applied for via the patent application with the title “Bundled Enterprise Application Users.” Invention may be used interchangeably with “enterprise application(s).”

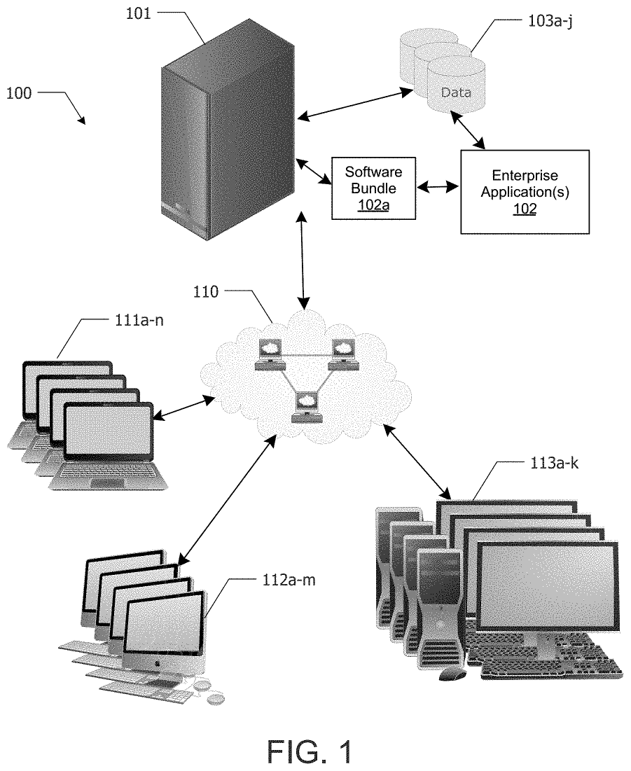

In general, the present disclosure relates to a system and method for providing enterprise applications to users. To better understand the present invention, FIG. 1 illustrates an example embodiment for a system 100 that provides enterprise software applications to a plurality of bundled users according to the present invention. In the system 100, a server 101 hosts an enterprise application 102 that is made available to users from company A 111a-n, company B 112a-m, and company C 113a-k over the Internet 110. The enterprise application 102 stores user data onto one or more storage devices 103a-j. The users from these multiple companies are bundled together to behave as a larger set of users that permits affordable economies of scale for using the enterprise application 102, which includes both licensing costs for the enterprise application 102 and hosting costs for use of the server 101. By combining these users into a bundle, these costs are shared and makes the costs to each company manageable.

The bundling of users relates to any process whereby a group (defined as two or more) small companies are bundled together as a legal entity for the sole purpose of cost-sharing the purchase and implementation of a large software enterprise. This includes enterprise systems throughout the value chain such as middle-ware and end-ware systems.

The bundling software 102a creates data security within the bundled enterprise application 102 to protect the data 103a-j that an organization collects, stores, creates, receives, and transmits. The bundling software 102a addresses security issues per the software standards including critical asset identification, secure default configuration, sensitive data protection, authentication and access control, attack detection, and vendor security guidance.

The specific functions of the bundling software 102a depend upon available user grouping and security functions provided natively within the enterprise application 102. The bundling software 102a processes all user data messages to and from the enterprise application 102 to provide segregation of the users from the bundled companies and protection of user data while residing within the server 101.

It is important to note that the legal entity used to “bundle” small companies is limited in scope exclusively to procure, implement, and maintain large software enterprise applications. Each participating company has no knowledge of, or access to, the other participants and their data in the bundle. This level of access is limited to the process company. The bundle software 102a is constructed to maximize economies of scale and similarity regarding the participating companies. Operators of the bundler software 102a and the hosting server 101 have the option to reform or reconstruct bundles going forward based on size, growth or other related changes of the participating companies.

The strength of this process innovation is based on the fact that there is no harm to any of the participating entities. Small companies that participate in the bundles receive superior large-scale applications at an affordable price. The cost sharing aspect of implementation and maintenance should also result in cost savings.

There is no harm to the software licensing companies. First, the bundle application 102a for each software system will be of a comparable size to their existing customers. Second, these enterprise application providers have been heretofore out of reach for these smaller companies due to the fact that they cannot afford their applications. In fact, this process opens up a significant market to the application companies and also incorporates smaller firms into their systems.

The invention may use any type of network such as a single network, multiple networks of a same type or multiple networks of different types which may include one or more of a direct connection between devices, including but not limited to a local area network (LAN), a wide area network (WAN) (for example, the Internet), a metropolitan area network (MAN), a wireless network (for example, a general packet radio service (GPRS) network), a long term evolution (LTE) network, a telephone network (for example, a public switched telephone network or a cellular network), a subset of the Internet, an ad hoc network, a fiber optic network (for example, a fiber optic service (often known as FiOS) network), or any combination of the above networks.

Smart devices mentioned herein the present application may also use one or more sensors to receive or send signals, such as wireless signals such as Bluetooth™, wireless fidelity, infrared, Wi-Fi or LTE. Any smart device mentioned in this application may be connected to any other component or smart device via wired communications (e.g., conductive wire, coaxial cable, fiber optic cable, ethernet cable, twisted pair cable, transmission line, waveguide, etc.), or a combination of wired and wireless communications. The invention's method and/or system may use a single server device or a collection of multiple server devices and/or computer systems.

The systems and methods described above, may be implemented in many different forms of applications, software, firmware, and hardware. The actual software or smart device application codes or specialized control software, hardware or smart device application(s) used to implement the invention's systems and methods is not limiting of the implementation. Thus, the operation and behavior of the systems and methods were described without reference to the specific software or firmware code. Software, smart device application(s), firmware, and control hardware can be designed to implement the systems and methods based on the description herein.

While all of the above functions are described to be provided to users via a mobile application on a smartphone, one of ordinary skill will recognize that any computing device including tablets, laptops, and general purpose computing devices may be used as well. In at least one embodiment, all of the services described herein are provided using web pages being accessed from the web server 201 using a web browser such as Safari™, Firefox™, Chrome™ DuckDuckGo™, and the like. All of the screen examples described herein show user interface elements that provide the functionality of the present invention. The arrangement, organization, presentation, and use of particular user input/output (I/O) elements including hyperlinks, buttons, text fields, scrolling lists, and similar I/O elements are shown herein for example embodiments only to more easily convey the features of the present invention. The scope of the present invention should not be interpreted as being limited by any of these elements unless expressly recited within the attached claims.

For the purposes of the example embodiment of FIG. 1, various functions are shown to be performed on different programmable computing devices that communicate with each other over the Internet 105. These computing devices may include smartphones 101a, laptop computers 101b, tablets (not shown), and similar devices so long as the disclosed functionality of the mobile application described herein is supported by the particular computing device. One of ordinary skill will recognize that this functionality is grouped as shown in the embodiment for clarity of description. Two or more of the processing functions may be combined onto a single processing machine. Additionally, it may be possible to move a subset of processing from one of the processing systems shown here and retain the functionality of the present invention. The attached claims recite any required combination of functionality onto a single machine, if required, and all example embodiments are for descriptive purposes.

For all of the above devices that are in communication with each other, some or all of them need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects, and in order to more fully illustrate one or more aspects. Similarly, although process steps, method steps, algorithms or the like may be described in a sequential order, such processes, methods, and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method or algorithm is carried out or executed. Some steps may be omitted in some aspect or some occurrences or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC) or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example, an end-user computer system, a client computer, a network server or other server system, a mobile computing device (e.g., tablet computing device, mobile phone, smartphone, laptop or other appropriate computing device), a consumer electronic device, a music player or any other suitable electronic device, router, switch or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines or other appropriate virtual environments).

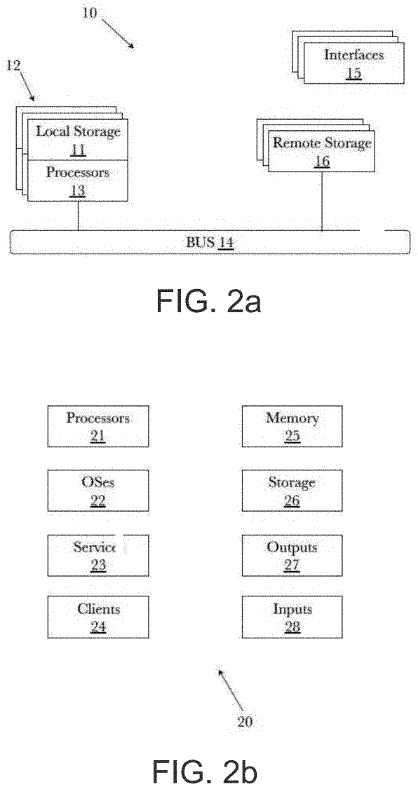

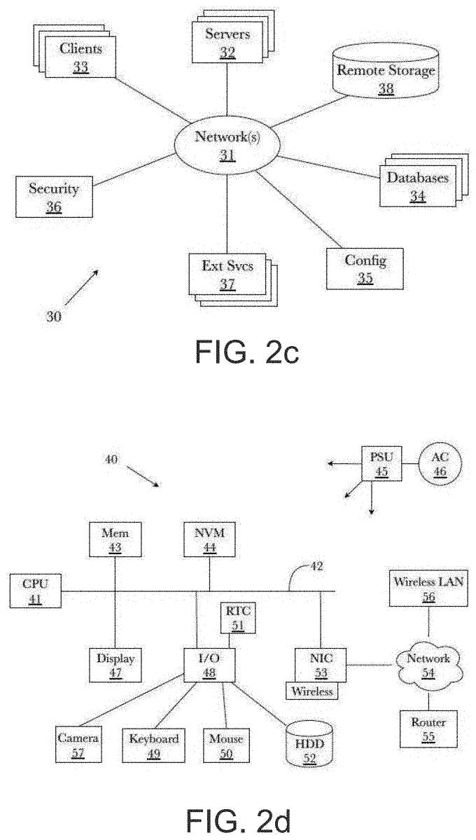

Referring now to FIG. 2a, there is a block diagram depicting an exemplary computing device 10 suitable for implementing at least a portion of the features or functionalities disclosed herein. The computing device 10 may be, for example, any one of the computing machines listed in the previous paragraph, or indeed any other electronic device capable of executing software- or hardware-based instructions according to one or more programs stored in memory. The computing device 10 may be configured to communicate with a plurality of other computing devices, such as clients or servers, over communications networks such as a wide area network, a metropolitan area network, a local area network, a wireless network, the Internet or any other network, using known protocols for such communication, whether wireless or wired.

In one aspect, the computing device 10 includes one or more central processing units (CPU) 12, one or more interfaces 15, and one or more buses 14 (such as a peripheral component interconnect (PCI) bus). When acting under the control of appropriate software or firmware, the CPU 12 may be responsible for implementing specific functions associated with the functions of a specifically configured computing device or machine. For example, in at least one aspect, a computing device 10 may be configured or designed to function as a server system utilizing a CPU 12, local memory 11 and/or remote memory 16, and interface(s) 15. In at least one aspect, a CPU 12 may perform one or more of the different types of functions and/or operations under the control of software modules or components, which for example, may include an operating system and any appropriate applications software, drivers, and the like.

A CPU 12 may include one or more processors 13 such as for example, a processor from one of the Intel, ARM, Qualcomm, and AMD families of microprocessors. In some aspect, processors 13 may include specially designed hardware such as application-specific integrated circuits (ASICs), electrically erasable programmable read-only memories (EEPROMs), field-programmable gate arrays (FPGAs), and so forth, for controlling operations of a computing device 10. In a particular aspect, a local memory 11 (such as non-volatile random access memory (RAM) and/or read-only memory (ROM), including for example, one or more levels of cached memory) may also form part of a CPU 12. However, there are many different ways in which memory may be coupled to a system 10. Memory 11 may be used for a variety of purposes such as, for example, caching and/or storing data, programming instructions, and the like. It should be further appreciated that a CPU 12 may be one of a variety of system-on-a-chip-(SOC) type hardware that may include additional hardware such as memory or graphics processing chips, such as a QUALCOMM SNAPDRAGON™ or SAMSUNG EXYNOS™ CPU as are becoming increasingly common in the art use in mobile devices or integrated devices.

As used herein, the term “processor” is not limited merely to those integrated circuits referred to in the art as a processor, a mobile processor or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may, for example, support other peripherals used with a computing device 10. Among the interfaces that may be provided are ethernet interfaces, frame relay interfaces, cable interfaces, DSL interfaces, token ring interfaces, graphics interfaces, and the like. In addition, various types of interfaces may be provided such as, for example, universal serial bus (USB), serial, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast ethernet interfaces, gigabit ethernet interfaces, serial ATA (SATA) or external SATA (ESATA) interfaces, high-definition multimedia interfaces (HDMI), digital visual interfaces (DVI), analog or digital audio interfaces, asynchronous transfer mode (ATM) interfaces, high-speed serial interfaces (HSSI), point of sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 2a illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and a server system (such as a server system described in more detail below).

Regardless of network device configuration, the system of an aspect may employ one or more memories or memory modules (for example, remote memory block 16 and local memory 11) configured to store data, program instructions for the general-purpose network operations or other information relating to the functionality of the aspects described herein (or any combination of the above). Program instructions may control execution of or comprise an operating system and/or one or more applications, for example. Memory 16 or memories 11, 16 also may be configured to store data structures, configuration data, encryption data, historical system operations information or any other specific or generic non-program information described herein.

Because such information and program instructions may be employed to implement one or more systems or methods described herein, at least some network device aspects may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks; and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device) or they may be removable such as swappable flash memory modules (such as “thumb drives” or other removable media designed for rapidly exchanging physical storage devices), “hot-swappable” hard disk drives or solid state drives, removable optical storage disks, or other such removable media, and that such integral and removable storage media may be utilized interchangeably. Examples of program instructions include both object code, such as may be produced by a compiler, machine code, such as may be produced by an assembler or a linker, byte code, such as may be generated by for example by a JAVA™ compiler and may be executed using a JAVA™ virtual machine or equivalent, or files containing higher level code that may be executed by the computer using an interpreter (for example, scripts written in Python™, Perl™, Ruby™, Groovy™, or any other scripting language).

In some aspects, systems may be implemented on a standalone computing system. Referring now to FIG. 2b, there is a block diagram depicting a typical exemplary architecture of one or more aspects or components thereof on a standalone computing system. A computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the LINUX™ operating system, ANDROID™ operating system or the like. In many cases, one or more shared services 23 may be operable in a system 20, and may be useful for providing common services to client applications 24. Services 23 may, for example, be WINDOWS™ services, user-space common services in a LINUX™ environment or any other type of common service architecture used with an operating system 21. Input devices 28 may be of any type suitable for receiving user input including, for example, a keyboard, touchscreen, microphone (for example, for voice input), mouse, touchpad, trackball or any combination thereof. Output devices 27 may be of any type suitable for providing output to one or more users, whether remote or local to system 20, and may include, for example, one or more screens for visual output, speakers, printers or any combination thereof. Memory 25 may be RAM having any structure and architecture known in the art for use by processors 21, for example to run software. Storage devices 26 may be any magnetic, optical, mechanical, memristor or electrical storage device for storage of data in digital form (such as those described above, referring to FIG. 2a). Examples of storage devices 26 include flash memory, magnetic hard drive, CD-ROM, and the like.

In some aspects, systems may be implemented on a distributed computing network, such as one having any number of clients and/or servers. Referring now to FIG. 2c, there is a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in Fig. B. In addition, any number of servers 32 may be provided for handling requests received from one or more clients 33. Clients 33 and servers 32 may communicate with one another via one or more electronic networks 31, which may be in various aspects any Internet, wide area network, mobile telephony network (such as CDMA or GSM cellular networks), wireless network (such as WiFi, WiMAX, LTE, and so forth) or local area network (or indeed any network topology known in the art; the aspect does not prefer any one network topology over another). Networks 31 may be implemented using any known network protocols, including, for example, wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored on a server system 32 in the Cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and use a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web system. It should be understood by one having ordinary skill in the art that any configuration or security subsystems known in the art now or in the future may be used in conjunction with aspects without limitation, unless a specific security 36 or configuration system 35 or approach is required by the description of any specific aspect.

FIG. 2d shows an exemplary overview of a computer system 40 as may be used in any of the various locations throughout the system. It is exemplary of any computer that may execute code to process data. Various modifications and changes may be made to a computer system 40 without departing from the broader scope of the system and method disclosed herein. A CPU 41 is connected to a bus 42, to which bus is also connected to memory 43, nonvolatile memory 44, display 47, I/O unit 48, and network interface card (NIC) 53. An I/O unit 48 may, typically, be connected to peripherals such as a keyboard 49, pointing device 50, hard disk 52, real-time clock 51, camera 57, and other peripheral devices. A NIC 53 connects to a network 54, which may be the Internet or a local network, which local network may or may not have connections to the Internet. The system may be connected to other computing devices through the network via a router 55, wireless local area network 56 or any other network connection. Also shown as part of a system 40 is a power supply unit 45 connected, in this example, to a main alternating current (AC) supply 46. Not shown are batteries that could be present and many other devices and modifications that are well known, but are not applicable to, the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles or other integrated hardware devices).

In various aspects, functionality for implementing systems or methods of various aspects may be distributed among any number of client and/or server components. For example, various software modules may be implemented for performing various functions in connection with the system of any particular aspect, and such modules may be implemented to run on server and/or client components.

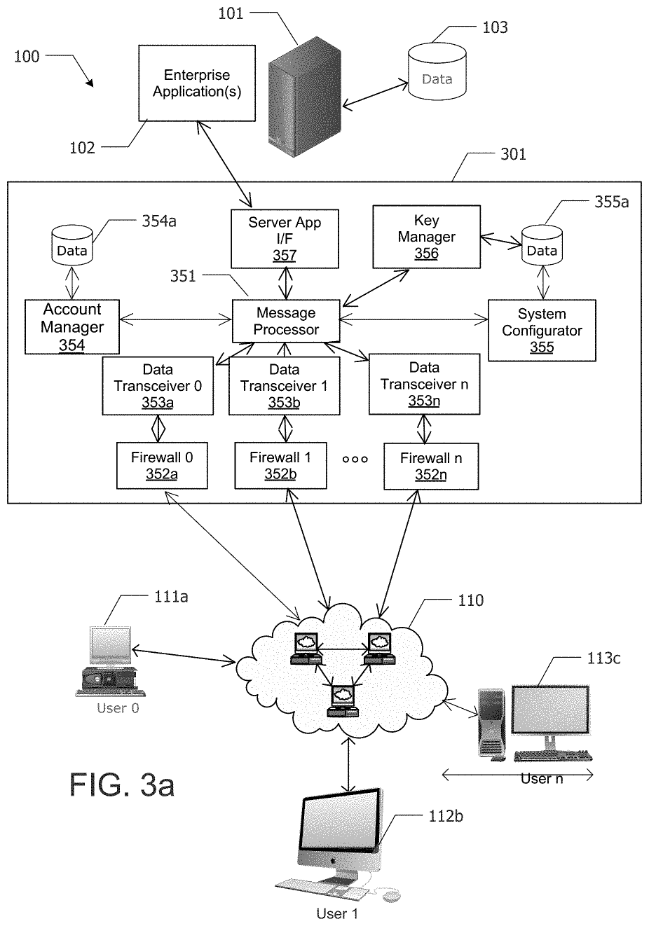

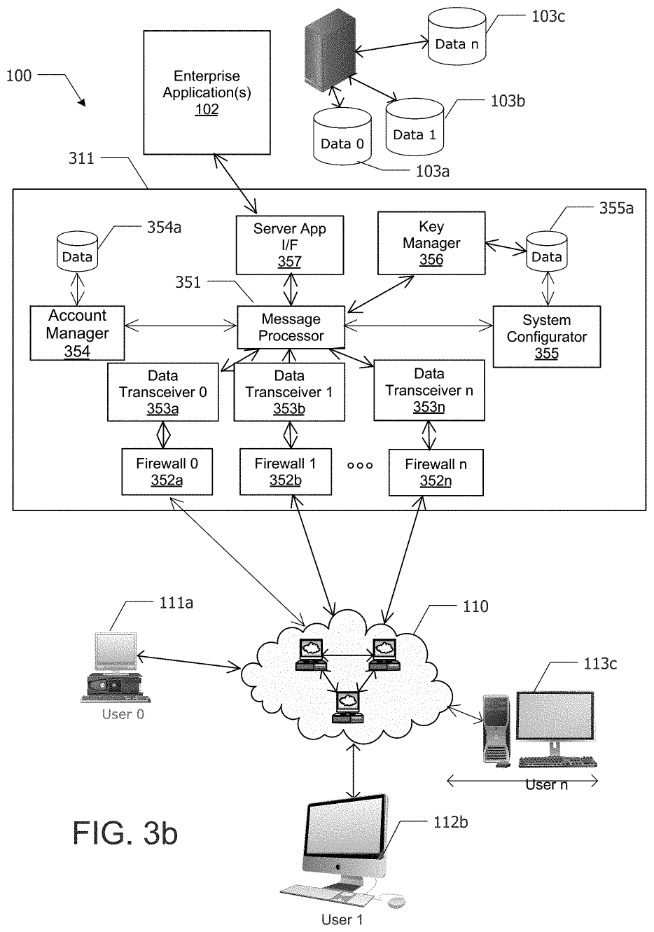

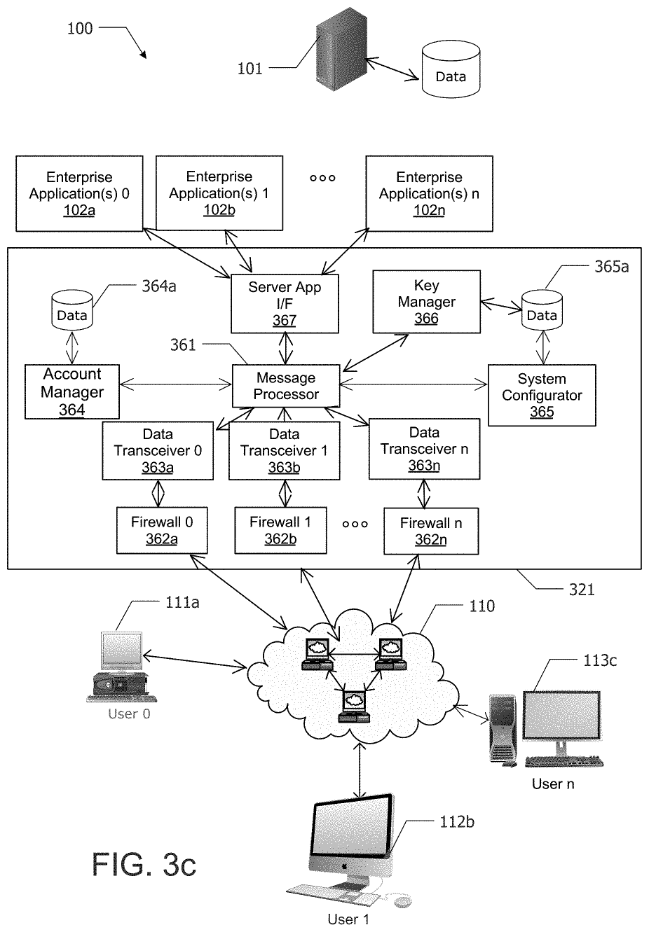

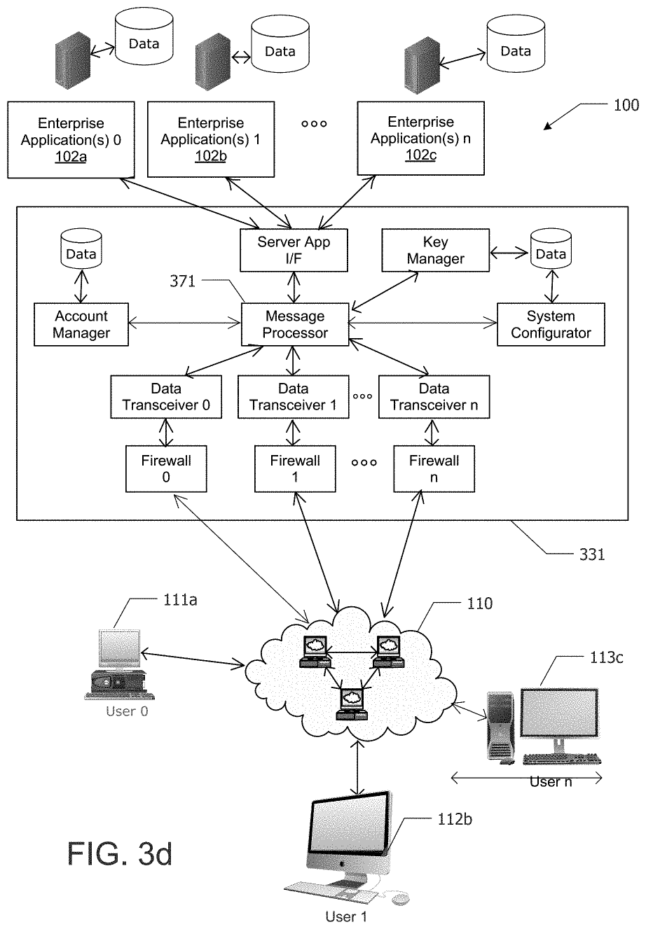

FIGS. 3a-d illustrate example embodiments of a system for providing enterprise software applications to a plurality of bundled users according to the present invention. FIG. 3a illustrates a first embodiment of the bundling software 301 that processes messages between users 111a, 112b, 113c and the enterprise application 102. In this particular embodiment, all of the users 111a, 112b, 113c are using a single instance of the enterprise application 102 running on a single server 101. The bundling software 301 is therefore responsible for ensuring that user data from each of the bundled companies are not accessible to all other users. The bundling software 301 utilizes functionality within the enterprise application 102 along with its own processing of messages to provide this security. For example, enterprise applications 102 that support multiple groups of users having similar access rights to data within the application may be utilized as part of segregating and separating data from these various groups as a mechanism to keep data from the multiple bundled smaller entities separate.

The bundling software 301 utilizes a message processor 351 to receive data messages and commands from users 111a, 112b, 113c and generate comparable data messages and commands for submission within the enterprise application 102. The message processor 351 also receives data responses from the enterprise application 102 for formatting and transmittal to the users 111a, 112b, 113c.

Each group of users communicates with the bundling software 301 via a separate firewall 352a-n. These firewalls 352a-n may be configured to meet any requirements for the corresponding group of users. Each firewall 352a-n may be assigned its own IP address permitting each group of users to communicate using its own address. Incoming messages and commands from the users 111a, 112b, 113c are passed by the firewalls 352a-n to separate data transceivers 353a-n. The data transceivers 353a-n receive the incoming messages and commands for ultimate processing by the message processor 351. The data transceivers 353a-n hold these received messages and commands until they may be processed. The messages and commands may be held within a data queue or similar memory buffer while awaiting further processing.

Once the messages and commands are retrieved by the message processor 351, each message and command is processed into a form that is required by the enterprise application 102 as well as required to provide segregation and security between users. The reformatted messages are then forwarded to the enterprise application 102 via a server application interface 357. If only one company was using the bundled software 301 to reach the enterprise application 102, the message processor would not be required to modify the messages and commands between users and the enterprise application. A client application running on a user's computer 111a, 112b, 113c would communicate with the enterprise server 102 in the same way large entities interact with the application. The bundling software 301 simply acts as a pass thru between the enterprise application 102 and the users 111a, 112b, 113c.

When multiple companies are bundled to the enterprise application 102, the bundling software 301 performs all necessary processing to permit the users from the multiple entities to appear to the enterprise application as if they were all related to a common entity. The functions required to perform this bundling typically include user account management and data encryption and security. The users of the enterprise application typically use an email address as a unique identifier for each user. The users from the multiple smaller entities typically possess email addresses referencing different domain identities. The message processor 351 is required to make any changes to the email addresses needed by the enterprise application 102 to allow the bundling to occur.

An account manager 354 may be utilized to identify authorized users from the bundled smaller entities. This account information may be maintained within a first local data storage 354a for use when performing user account processing. A key manager 356 manages any encryption keys used by the message processor 351 to protect any user data that is to be sent for storage within the enterprise application 102. Use of different encryption keys for each bundled entity will provide security to data stored within the server 101 if improperly accessed by users from other bundled entities after they gain access to the server 101. A system configurator 355 provides a mechanism for system administrators to set up and then manage user accounts and encryption keys as used within the message processor 301.

Once data and commands have been processed by the message processor 351, the messages are transmitted to the enterprise application 102. The enterprise application 102 typically generates a response to the submission of data and commands that it is to be returned to the users 111a, 112b, 113b. These responses are sent by the enterprise application 102 to the message processor 351 via the server application interface 357. The message processor 351 transforms the responses as required to direct them to users from the bundled entities. This transformation processing is the reverse of the process for messages from users to the enterprise application 102.

The message processor 351 completes the message and command transaction by sending the transformed response messages to the data transceiver 353a-n corresponding to the entity in which a particular user is a member. The transformed response messages are sent by the data transceivers 353a-n to users 111a, 112b, 113c over the Internet 110 through the corresponding firewall.

FIG. 3b illustrates a second embodiment for the bundled enterprise application system 100 in which the bundling software 311 acts in a similar manner as described above with the exception that data storage 103a-c provides separate data storage devices for each of the bundled entities. These separate data storage devices 103a-c may be separate physical storage devices and separate logical storage devices attached to a single instance of the enterprise application 102. In this embodiment, the enterprise application 102 must support directing data from different groups of users, where each of the different groups corresponds to a different bundled entity. Because these are viewed as separate storage devices 103a-c, encryption and related security processing may be different as the operating system (OS) and the enterprise application 102 provide much of the data segregation and separation for user data from the different bundled entities. In other respects, the message processor 351 performs the operations described above.

FIG. 3c illustrates another possible embodiment for the bundled enterprise application system 100. In this embodiment, a plurality of instances of the enterprise applications 102a-n are hosted on the same server 101. The bundling software 321 in this embodiment performs all of the functions described above except that the server application interface 367 directs messages to the appropriate instance of the enterprise application. The message processor 361 transforms the messages and commands to address the appropriate instance of the enterprise application 102a-n such that the server application interface 367 may direct the message and command accordingly.

In this embodiment, the multiple instances of the enterprise application 102a-n may be separate executing processes on the server 101 should the server support multiple instances of the same application as separately addressable processing threads. The multiple instances of the enterprise application 102a-n also may be encapsulated within a virtual server container that appears to locate each instance in a separate server that is merely a separate instance of a virtual server running on a common computing platform 101. Examples of these virtual server containers include ???. In either approach, the enterprise application 102a-n appears to be a single instance of the application to users that is hosted on an ordinary server connected to the Internet 110. The separate instance of a virtual server running on a common computing platform 101 typically provides data segregation and separation as each separate instance of a virtual server may only access data on the server 101 that has been mapped a logical drive for that separate instance of a virtual server.

FIG. 3d illustrates yet another possible embodiment for the bundled enterprise application system 100. In this embodiment, multiple instances of the enterprise application 102a-n are hosted on an identical number of hardware servers 101a-n. In such an embodiment, the bundling software 331 may possess the same set of processing modules as described above; however, the message processor 371 may utilize the instances of enterprise application 102a-n to provide data segregation and separation. Depending upon how a licensing agreement for the enterprise application is written, each bundled entity may be able to use its own email addresses and not require much, if any, processing within the message processor 371 and related components. In such an embodiment, the bundling is merely a legal construct between the developer of the enterprise application 102a-n and the bundling entity with the bundled smaller entities obtaining licensing rights through the bundling entity.

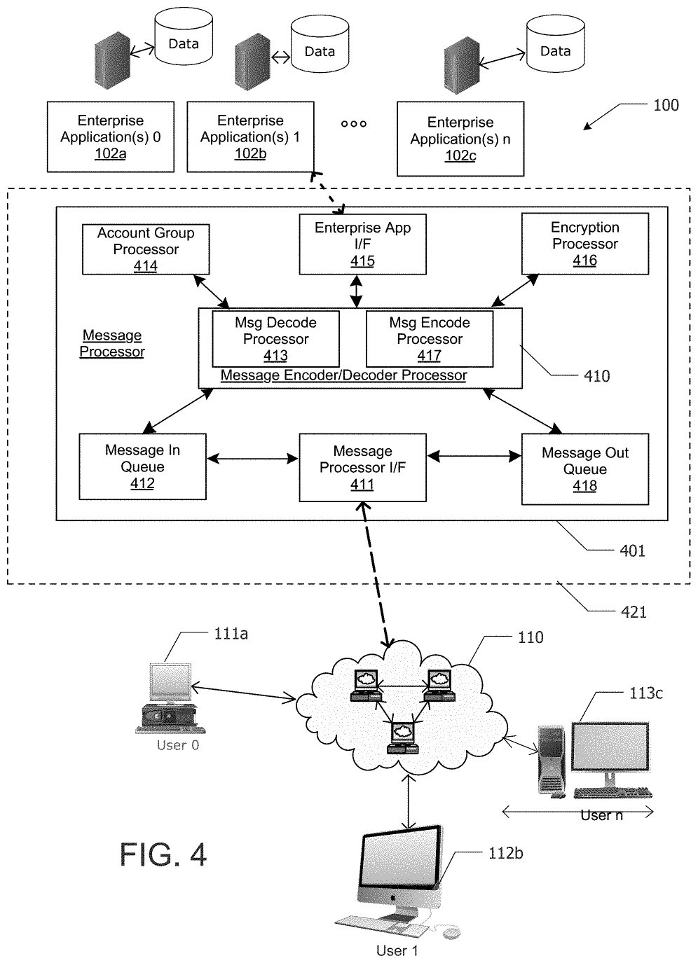

FIG. 4 illustrates a computing system of software components within a message processor providing enterprise software applications to a plurality of bundled users according to the present invention. As discussed above with reference to the various embodiments of the bundling software 301, the message processor 421 receives all messages and commands from the users 111a, 112b, 113c and transforms them into messages and commands that may be submitted to the enterprise application 102a-n. The message processor 421 also receives responses from the enterprise application 102a-n and transforms the response data into a format to be sent to the users 111a, 112b, 113c. While the embodiment of FIG. 4 shows a system 100 that includes a plurality of servers 101a-n and corresponding instances of the enterprise application 102a-n, one of ordinary skill in the art will recognize that this embodiment of the message processor 421 is also applicable to the various embodiments of the bundling software 401 as described above in reference to FIGS. 3a-d.

Incoming messages and commands are received from users 111a, 112b, 113c via the message processor interface 411 and stored within a message in queue 412. A message encoder/decoder processor 410 retrieves the incoming messages from the message in queue 412 one at a time. The message encoder/decoder processor 410 includes a message decoder processor 413 and a message encoder processor 417. Messages and commands retrieved from the message in queue 412 are passed to the message decoder processor 413 to perform the previously described message and data transformation to make incoming messages and commands received from users of separate smaller entities into formats compatible with the instance of the enterprise application 102a-n that is to receive the message and command. The decoder message processor 413 utilizes an account group processor 414 to transform users from separate entities into a single bundle entity as required to perform the necessary data transformation. The decoder message processor 413 utilizes an encryption processor 416 to encrypt data as necessary before it is passed onward. The transformed message and commands are passed to the appropriate instance of enterprise application 102a-n via an enterprise application interface 415.

Response data and messages from the various instances of the enterprise application 102a-n is received by the message processor 401 in response to the received messages and commands. The response data and messages are received by the enterprise application interface 415 and passed to the message encoder processor 417. The account group processor 414 and the encryption processor 416 work with the message encoder processor 417 to generate response data and messages compatible with the users 111a, 112b, 113c from the various bundled entities. The response data and messages are then stored into a message out queue 418 for transmission to the appropriate user 111a, 112b, 113c via the message processor interface 411. All messages and commands are received and processed as disclosed above to return response data and messages from the enterprise application 102a-n.

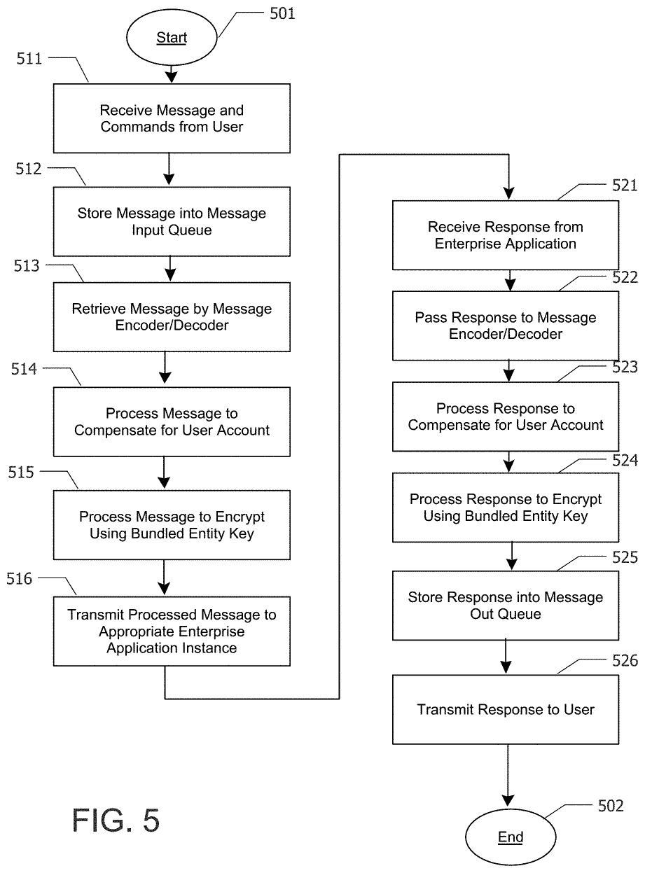

FIG. 5 illustrates a flowchart corresponding to a method performed by software components providing enterprise software applications to a plurality of bundled users. The process begins 501 and a message and command data are transmitted by a user and received in step 511 by a data transceiver and corresponding firewall. In step 512, the message and command data are passed to the message processor interface and stored into a message in queue.

The message encoder/decoder processor retrieves the message and command data from the message in queue in step 513. The message decoder processor, in step 514, processes the message and command data with the account group processor. The encryption processor assists the message decoder processor to transform the message and command data into secure data in step 515. The transformed message and command data are sent to an appropriate instance of the enterprise application in step 516.

The instance of the enterprise application returns a response message and data, in step 521, and passes response in step 522 to the message encoder/decoder processor. In step 523, the encryption processor assists the message encoder processor to transform the response and message data. The message encoder processor, in step 524, processes the response and message data with the account group processor into user data. The response and message data in the user data format is stored into the message out queue in step 525. In step 526 the response and message data in the user data format are retrieved from the message out queue and sent to the user and the process ends 502.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps or modules.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act or instruction used in the present application should be construed as critical or essential to the invention unless explicitly described as such. Further, the phrase “based on” is intended to mean “based, at least in part, on” unless explicitly stated otherwise.

In the present application, all or any part of the invention's software or application(s) or smart device application(s) may be installed on any of the user's or operator's smart device(s), any server(s) or computer system(s) or web application(s) required to allow communication, control (including but not limited to control of parameters, settings such as for example, sign copy brightness, contrast, ambient light sensor settings, etc.), transfer of content(s) or data between any combination of the components.

What is claimed is:

1. A system for providing an enterprise software application to a plurality of bundled users, the system comprising:
a message processor for receiving data and commands from an individual user within the plurality of bundled users for submission to the enterprise application and for returning responses from the enterprise application to the individual user;
an account manager for managing the plurality of bundled users into a set of user groups, each of the set of user groups correspond to the individual users being employed by different legal entities; and
a firewall for each set of user groups to segregate and separate the data, commands and responses sent and received by each of the individual users from data associated with users from a different user group;
wherein each of the set of users groups utilize an instance of a client application to interact with the enterprise application by sending data and commands to the message processor and receiving responses generated by the message processor.

2. The system according to claim 1, wherein the system further comprises:
a key manager for maintaining at least one encryption key for each user group within the set of user groups, the encryption key being used by the message processor to encrypt and decrypt data, commands and responses between the individual user and the enterprise application.

3. The system according to claim 2, wherein the system further comprises:
a system configurator for creating and maintaining each user group and its individual users within the set of user groups; and
a data store for use by the account manager, system configurator, and the key manager to maintain local data used by the message processor.

4. The system according to claim 2, wherein the message processor comprises:
a message in queue for receiving data and commands from individual users until processed by the message processor;
a message decoder/encoder processor for transforming data, commands, and responses between the individual users and the enterprise application to account for the individual user being from the set of user groups; and
an account group processor for assisting the message decoder/encoder processor regarding individual users from the set of user groups defining the transformation performed.

5. The system according to claim 4, wherein the message processor further comprises:
an encryption processor encrypting and decrypting message data, commands, and responses for the individual users of the set of user groups using the encryption keys associates with the particular user group the individuals are members; and
a message out queue for storing responses to individual users within the message processor before the responses are transmitted.

6. The system according to claim 5, wherein the enterprise application supporting each group of users within the set of user groups executes on a separate processing platform.

7. The system according to claim 5, wherein the enterprise application supporting each group of users within the set of user groups executes within a separate virtual server in which the virtual servers execute on the same processing platform.

8. The system according to claim 5, wherein the enterprise application supporting each group of users within the set of user groups executes on a common processing platform while storing user data within a datastore is maintained within separate storage device for each group of users.

9. The system according to claim 8, wherein the separate storage devices correspond to logical storage volumes on a storage system.

10. The system according to claim 5, wherein the enterprise application supporting each group of users within the set of user groups executes on a single processing platform.

11. A system for providing an enterprise software application to a plurality of bundled users, the system comprising:
a message processor for receiving data and commands from an individual user within the plurality of bundled users for submission to the enterprise application and for returning responses from the enterprise application to the individual user,
the message processor comprises:
a message in queue for receiving data and commands from individual users until processed by the message processor;
a message decoder/encoder processor for transforming data, commands, and responses between the individual users and the enterprise application to account for the individual user being from the set of user groups;
an encryption processor encrypting and decrypting message data, commands, and responses for the individual users of the set of user groups using the encryption keys associates with the particular user group the individuals are members;
a message out queue for storing responses to individual users within the message processor before the responses are transmitted and
an account group processor for assisting the message decoder/encoder processor regarding individual users from the set of user groups defining the transformation performed;
an account manager for managing the plurality of bundled users into a set of user groups, each of the set of user groups correspond to the individual users being employed by different legal entities; and
a firewall for each set of user groups to segregate and separate the data, commands and responses sent and received by each of the individual users from data associated with users from a different user group;
a key manager for maintaining at least one encryption key for each user group within the set of user groups, the encryption key being used by the message processor to encrypt and decrypt data, commands and responses between the individual user and the enterprise application;
a system configurator for creating and maintaining each user group and its individual users within the set of user groups; and
a data store for use by the account manager, system configurator, and the key manager to maintain local data used by the message processor;
wherein each of the set of users groups utilize an instance of a client application to interact with the enterprise application by sending data and commands to the message processor and receiving responses generated by the message processor.

12. A method for providing enterprise software applications to a plurality of bundled users, the method comprising:
receiving message data and commands from an individual user;
storing the message data and commands within a message processor;
processing the message to compensate for the individual user being a member of a particular user group from a set of user groups, the particular user group contains a set of users from the plurality of bundled users, each of the set of user groups correspond to the individual users being employed by different legal entities;
transmitting the processed message to an appropriate instance of the enterprise application associated with the particular user group;
receiving a response message from the appropriate instance of the enterprise application for returning to individual user;
processing the response message to compensate for the individual user being a member of a particular user group; and
transmitting the processed response message to the individual user.

13. The method according to claim 12, wherein the enterprise application supporting the particular user group of users within the set of user groups executes within a separate virtual server in which the virtual servers execute on the same processing platform.

14. The method according to claim 12, wherein the enterprise application supporting the particular user group of users within the set of user groups executes on a common processing platform while storing user data within a datastore is maintained within separate storage device for each group of users.

15. The method according to claim 12, wherein the enterprise application supporting the particular user group of users within the set of user groups executes on a single processing platform.
